(19) United States
(12) Patent Application Publication
(10) Pub. No.: US 2015/0373986 A1
(43) Pub. Date: Dec. 31, 2015

(54) PROCESS AND COMPOSITION FOR KILLING SPORES

(71) Applicant: American Sterilizer Company, Mentor, OH (US)

(72) Inventors: Peter A. Burke, Concord, OH (US); Mark James Leggett, Cardiff (GB); Michael A. Centanni, Parma, OH (US)

(21) Appl. No.: 14/847,022

(22) Filed: Sep. 8, 2015

Related U.S. Application Data
(62) Division of application No. 14/525,497, filed on Oct. 28, 2014.
Application No. 14/525,497 is a continuation-in-part of application No. 14/262,840, filed on Apr. 28, 2014.

(51) Int. Cl. A01N 59/00; A01N 37/16

(52) U.S. Cl. CPC A01N 59/00; A01N 37/16

(57) ABSTRACT

This invention relates to an aqueous composition and a process for killing spores. The process may comprise contacting the spores with the aqueous composition for a sufficient period of time to effect a desired reduction (e.g., at least a 4 log reduction) in the number of spores capable of returning to vegetative growth. The aqueous composition may comprise water, an antimicrobial agent (e.g., peracetic acid) and a peroxide (e.g., hydrogen peroxide). The process may be a two-step process involving the use of a first aqueous composition, which may comprise water and the peroxide, and a second aqueous composition which may comprise water and the antimicrobial agent.

This is a continuation-in-part of U.S. application Ser. No. 14/262,840, filed Apr. 28, 2014. This prior application is incorporated herein by reference in its entirety.

### TECHNICAL FIELD

This invention relates to a process for killing spores, and to an aqueous composition containing an antimicrobial agent (e.g., peracetic acid) and a peroxide (e.g., hydrogen peroxide) for use in the process for killing spores.

### BACKGROUND

Spores are a highly resistant, dormant cell type formed by some types of bacteria. Endospores (or simply spores) form within the vegetative mother cell in response to adverse changes in the environment, most commonly nutrient depletion. The mother cell undergoes an asymmetrical cell division, where it replicates its genetic material, which is then surrounded by multiple concentric and spore specific layers. The mother cell then disintegrates, releasing the mature dormant spore which requires neither nutrients, water nor air for survival and is protected against a variety of trauma, including extremes of temperature, radiation, and chemical assault. Spore forming bacteria cause a number of serious diseases in humans, including botulism, gas gangrene, tetanus, and acute food poisoning. Anthrax results from infection by the aerobic spore form Bacillus anthracis.

### SUMMARY

Spores are difficult to kill and a problem in the art of sterilization relates to providing an effective process for killing spores. This invention provides a solution to this problem. This invention relates to a process for killing spores and to an aqueous composition for use in the process. The aqueous composition may comprise water, an antimicrobial agent (e.g., peracetic acid) and a peroxide (e.g., hydrogen peroxide). The process may comprise contacting the spores with the aqueous composition to kill the spores. Alternatively, the process may comprise a two-step process that employs a first aqueous composition comprising water and the peroxide, and a second aqueous composition comprising water and the antimicrobial agent, the process comprising contacting the spores with these aqueous compositions to kill the spores. With this alternative the spores may be contacted with the first and second aqueous compositions either simultaneously or sequentially.

This invention relates to an aqueous composition for killing spores, comprising: water; an antimicrobial agent; and a peroxide; the concentration of the peroxide being in the range from about 0.01 to about 14% by weight, or from about 0.01 to about 12% by weight, or from about 0.01 to about 10% by weight, or from about 0.01 to about 8% by weight, or from about 0.01 to about 7% by weight, or from about 0.05 to about 7% by weight, or from about 0.1 to about 7% by weight, or from about 0.1 to about 6.5% by weight. In an embodiment, the concentration of the antimicrobial agent is in the range from about 0.001 to about 95% by weight, or from about 0.001 to about 80%, or from about 0.001 to about 60% by weight, or from about 0.001 to about 30% by weight, or from about 0.001 to about 10% by weight, or from about 0.001 to about 5% by weight, or from about 0.001 to about 2% by weight, or from about 0.001 to about 1% by weight, or from about 0.001 to about 0.5% by weight, or from about 0.001 to about 0.4% by weight, or from about 0.001 to about 0.3% by weight, or from about 0.001 to about 0.2% by weight, or from about 0.001 to about 0.16% by weight. In an embodiment, the concentration of the antimicrobial agent is in the range from about 0.005 to about 0.5% by weight, or from about 0.005 to about 0.4% by weight, or from about 0.005 to about 0.3% by weight, or from about 0.005 to about 0.2% by weight, or from about 0.005 to about 0.18% by weight, or from about 0.005 to about 0.16% by weight. In an embodiment, the weight ratio of the antimicrobial agent to the peroxide is in the range from about 0.001 to about 0.5, or from about 0.003 to about 0.4, or from about 0.006 to about 0.3, or from about 0.008 to about 0.2, or from about 0.01 to about 0.1.

This invention relates to an aqueous composition for killing spores, comprising: water; peracetic acid; and hydrogen peroxide; the concentration of peracetic acid in the water being in the range from about 0.001 to about 60% by weight, or from about 0.001 to about 30% by weight, or from about 0.001 to about 10% by weight, or from about 0.001 to about 5% by weight, or from about 0.001 to about 2% by weight, or from about 0.001 to about 1% by weight, or from about 0.001 to about 0.5% by weight, or from about 0.005 to about 0.4% by weight, or from about 0.01 to about 0.3% by weight, or from about 0.05 to about 0.3% by weight; the weight ratio of peracetic acid to hydrogen peroxide being in the range from about 0.001 to about 0.5, or from about 0.003 to about 0.4, or from about 0.006 to about 0.3, or from about 0.008 to about 0.2, or from about 0.01 to about 0.1.

This invention relates to an aqueous composition for killing bacterial spores, comprising: water; peracetic acid; and hydrogen peroxide; the concentration of peracetic acid in the water being in the range from about 0.001 to about 0.5% by weight; the weight ratio of peracetic acid to hydrogen peroxide being in the range from about 0.001 to about 0.5.

This invention relates to a process for killing spores, comprising: contacting the spores with an aqueous composition comprising water, an antimicrobial agent and a peroxide for a period of time sufficient to effect at least a 4 log reduction, or at least a 5 log reduction, or at least a 6 log reduction in the number of spores capable of returning to vegetative growth, the aqueous composition having a concentration of peroxide in the water in the range from about 0.01 to about 14% by weight, or from about 0.01 to about 12% by weight, or from about 0.01 to about 10% by weight, or from about 0.01 to about 8% by weight, or from about 0.01 to about 7% by weight, or from about 0.05 to about 7% by weight, or from about 0.1 to about 7% by weight, or from about 0.1 to about 6.5% by weight. In an embodiment, the concentration of the antimicrobial agent is in the range from about 0.001 to about 95% by weight, or from about 0.001 to about 80%, or from about 0.001 to about 60% by weight, or from about 0.001 to about 30% by weight, or from about 0.001 to about 10% by weight, or from about 0.001 to about 5% by weight, or from about 0.001 to about 2% by weight, or from about 0.001 to about 1% by weight, or from about 0.001 to about 0.5% by weight, or from about 0.001 to about 0.4% by weight, or from about 0.001 to about 0.3% by weight, or from about 0.001 to about 0.2% by weight, or from about 0.001 to about 0.16% by weight. In an embodiment, the concentration of the antimicrobial agent is in the range from about 0.005 to about 0.5% by weight, or from about 0.005 to about 0.4% by weight, or from about 0.005 to about 0.3% by weight, or from about 0.005 to about 0.2% by weight, or from about 0.005 to about 016% by weight. In an embodiment, the weight ratio of the antimicrobial agent to the peroxide is in the range from about 0.001 to about 0.5, or from about 0.003 to about 0.4, or from about 0.006 to about 0.3, or from about 0.008 to about 0.2, or from about 0.01 to about 0.1. The time required to effect at least a 4 log reduction, or at least a 5 log reduction, or at least a 6 log reduction in the number of spores capable of returning to vegetative growth may be in the range from about 30 seconds to about 20 minutes, or from about 30 seconds to about 10 minutes.

This invention relates to a process for killing bacterial spores, comprising: contacting the spores with an aqueous composition comprising water, an antimicrobial agent and hydrogen peroxide for a period of time sufficient to effect at least a 4 log reduction, or at least a 5 log reduction, or at least a 6 log reduction in the number of spores capable of returning to vegetative growth, the aqueous composition having a concentration of hydrogen peroxide in the range from about 0.05 to about 7% by weight. The time required to effect at least a 4 log reduction, or at least a 5 log reduction, or at least a 6 log reduction in the number of spores capable of returning to vegetative growth may be in the range from about 30 seconds to about 20 minutes, or from about 30 seconds to about 10 minutes.

This invention relates to a process for killing spores, comprising: contacting the spores with an aqueous composition comprising water, peracetic acid and hydrogen peroxide for a period of time in the range from about 30 seconds to about 20 minutes, or from about 30 seconds to about 10 minutes to effect at least a 4 log reduction, or at least a 5 log reduction, or at least a 6 log reduction in the number of spores capable of reproduction, metabolism and/or growth, the aqueous composition having a concentration of peracetic acid in the water in the range from about 0.001 to about 60% by weight, or from about 0.001 to about 30% by weight, or from about 0.001 to about 10% by weight, or from about 0.001 to about 5% by weight, or from about 0.001 to about 2% by weight, or from about 0.001 to about 1% by weight, or from about 0.001 to about 0.5% by weight, or from about 0.005 to about 0.4% by weight, or from about 0.01 to about 0.3% by weight, or from about 0.05 to about 0.3% by weight; the weight ratio of peracetic acid to hydrogen peroxide being in the range from about 0.001 to about 0.5, or from about 0.003 to about 0.4, or from about 0.006 to about 0.3, or from about 0.008 to about 0.2, or from about 0.01 to about 0.1.

This invention relates to a process for killing bacterial spores, comprising: contacting the spores with an aqueous composition comprising water, peracetic acid and hydrogen peroxide for a period of time in the range from about 30 seconds to about 20 minutes to effect at least a 4 log reduction in the number of spores capable of reproduction, metabolism and/or growth, the aqueous composition having a concentration of peracetic acid in the water in the range from about 0.001 to about 0.5% by weight; the weight ratio of peracetic acid to hydrogen peroxide being in the range from about 0.001 to about 0.5.

This invention relates to a two-step process for killing spores, comprising: contacting the spores with a first aqueous composition comprising water and a peroxide, the aqueous composition having a concentration of peroxide in the range from about 0.01 to about 14% by weight, or from about 0.01 to about 12% by weight, or from about 0.01 to about 10% by weight, or from about 0.01 to about 8% by weight, or from about 0.01 to about 7% by weight, or from about 0.05 to about 7% by weight, or from about 0.1 to about 7% by weight, or from about 0.1 to about 6.5% by weight; and contacting the spores with a second aqueous composition comprising water and an antimicrobial agent for an effective period of time to effect at least a 4 log reduction, or at least a 5 log reduction, or at least a 6 log reduction in the number of spores capable of returning to vegetative growth. The first and second steps may be performed simultaneously, or sequentially with the first step preceding the second step. Alternatively, the first step may be commenced and then while continuing with the first step, the second step may be commenced. The concentration of the antimicrobial agent in the second aqueous composition may be in the range from about 0.001 to about 95% by weight, or from about 0.001 to about 80%, or from about 0.001 to about 60% by weight, or from about 0.001 to about 30% by weight, or from about 0.001 to about 10% by weight, or from about 0.001 to about 5% by weight, or from about 0.001 to about 2% by weight, or from about 0.001 to about 1% by weight, or from about 0.001 to about 0.5% by weight, or from about 0.001 to about 0.4% by weight, or from about 0.001 to about 0.3% by weight, or from about 0.001 to about 0.2% by weight, or from about 0.001 to about 0.16% by weight. The concentration of the antimicrobial agent in the second aqueous composition may be in the range from about 0.005 to about 0.5% by weight, or from about 0.005 to about 0.4% by weight, or from about 0.005 to about 0.3% by weight, or from about 0.005 to about 0.2% by weight, or from about 0.005 to about 016% by weight. The weight ratio of the antimicrobial agent to peroxide may be in the range from about 0.001 to about 0.5, or from about 0.003 to about 0.4, or from about 0.006 to about 0.3, or from about 0.008 to about 0.2, or from about 0.01 to about 0.1. The time required to effect at least a 4 log reduction, or at least a 5 log reduction, or at least a 6 log reduction in the number of spores capable of returning to vegetative growth may be in the range from about 30 seconds to about 20 minutes, or from about 30 seconds to about 10 minutes.

### BRIEF DESCRIPTION OF THE DRAWINGS

FIG. 1 is a schematic illustration of a bacterial spore that can be killed in accordance with the invention.

### DETAILED DESCRIPTION

All ranges and ratio limits disclosed in the specification and claims may be combined in any manner. It is to be understood that unless specifically stated otherwise, references to “a,” “an,” and/or “the” may include one or more than one, and that reference to an item in the singular may also include the item in the plural.

The phrase “and/or” should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements); etc.

The word “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” may refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The transitional words or phrases, such as “comprising,” “including,” “carrying,” “having,” “containing,” “involving,” “holding,” and the like, are to be understood to be open-ended, i.e., to mean including but not limited to.

The term “killing” (or “kill”) spores refers to rendering the spores incapable of returning to vegetative growth. In an embodiment, the term killing spores refers to rendering the spores incapable of reproduction, metabolism and/or growth.

The term “log reduction” is a mathematical term to show the number of live spores killed by contacting the spores with the aqueous composition of the invention. A “4 log reduction” means that the number of live spores is 10,000 times smaller. A “5 log reduction” means that the number of live spores is 100,000 times smaller. A “6 log reduction” means that the number of live spores is 1,000,000 times smaller.

The term “antimicrobial agent” refers to a substance that kills microorganisms or inhibits their growth.

The term “disinfectant” refers to a substance that is applied to non-living objects to kill or inhibit the growth of microorganisms that are on the objects.

The term “antibiotic” refers to a substance that kills or inhibits the growth of microorganisms within the body.

The term “antiseptic” refers to a substance that kills or inhibits the growth of microorganisms on living tissue.

The term “biocide” refers to a substance that kills or inhibits the growth of living organisms. The biocide can be a pesticide. The biocide can be a fungicide, herbicide, insecticide, algaecide, molluscicide, miticide or rodenticide.

The term “sanitizer” refers to a substance that cleans and disinfects.

The sterilization of spores is often taken as referring to a process for achieving a total absence of living spores. Processes that are less rigorous than sterilization may include, for example, disinfection, sanitization, decontamination, cleaning, and the like. The aqueous compositions and processes provided for herein may be used to achieve at least a 4 log reduction, or at least a 5 log reduction, or at least a 6 log reduction in the number of spores capable of returning to vegetative growth, or in an embodiment, capable of reproduction, metabolism and/or growth. When at least a 6 log reduction is achieved, the process may be referred to as a sterilization process. When a 4 log reduction or a 5 log reduction is achieved, the process may be considered to be less rigorous than a sterilization, but nevertheless useful for various disinfection, sanitization, decontamination and/or cleaning applications.

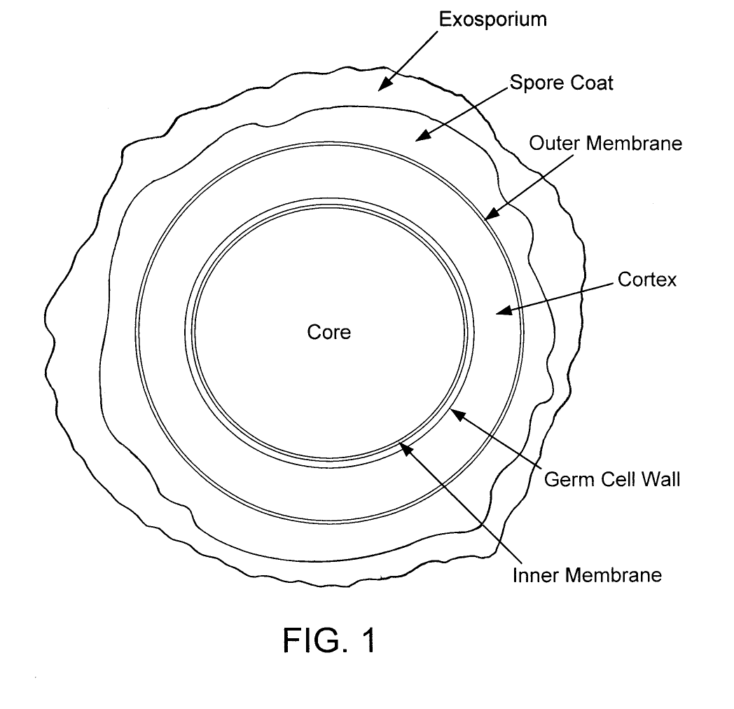

Bacterial spores typically comprise multiple concentric layers surrounding a central core. This is illustrated in FIG. 1 wherein a bacterial spore is shown which has a central core, inner membrane, germ cell wall, cortex, outer membrane, spore coat and occasionally an exosporium. Oxidizing agents for years have been thought to attack DNA, RNA, protein and most organic matter equally. However, while not wishing to be bound by theory, with the present invention it is believed that the mechanism that is provided involves the peroxide (e.g., hydrogen peroxide) first piercing holes in multiple layers surrounding the central core of the spores, and then the antimicrobial agent advancing through the pierced holes and attacking the central core to kill the spores. This mechanism is believed to occur when using aqueous compositions with relatively low concentrations of the peroxide (e.g., in the range from about 0.01 to about 7% by weight) and the antimicrobial agent (e.g., in the range from about 0.001 to about 0.5% by weight). In an embodiment, this mechanism is believed to occur when relatively low concentrations of the antimicrobial agent and peroxide are used, as indicated above, and the antimicrobial agent to peroxide weight ratio is relatively low (e.g., in the range from about 0.001 to about 0.5). Hence, in this embodiment, the ratio of antimicrobial agent to peroxide is important with respect to biocidal potentials.

In embodiments wherein the concentrations of the antimicrobial agent and peroxide are relatively low, as indicated above, advantages of the inventive process include relatively low costs due to the fact that the concentrations of the antimicrobial agent and peroxide used in the process are relatively low in comparison to normal concentrations used in other products using these ingredients. Other advantages of these embodiments include low levels of corrosion of surfaces treated due to the low concentrations of the antimicrobial agent and peroxide.

In an embodiment, higher concentrations of the antimicrobial agent, for example concentrations of antimicrobial agent of up to about 95% by weight, or up to about 60% by weight, and the peroxide, for example concentrations of up to about 14% by weight, may be used advantageously when the aqueous composition is applied to spores which are on a substrate. In this embodiment, some of the antimicrobial agent and peroxide may be absorbed and/or neutralized by the substrate. As a result, higher concentrations of the antimicrobial agent and peroxide may be required to kill the spores that are on the substrate. With this embodiment, it is believed that the above-indicated mechanism still applies, but the concentrations of antimicrobial agent and peroxide are increased to account for the fact that when applied to a substrate some of the antimicrobial agent and/or peroxide may be absorbed and/or neutralized by the substrate.

The water may comprise tap water, deionized water, distilled water, water purified by osmosis, or a mixture of two or more thereof.

The peroxide may comprise any compound containing an oxygen-oxygen single bond, or a peroxide group or peroxide ion. Examples include hydrogen peroxide; organic peroxides (e.g., benzoyl peroxide, acetyl acetone peroxide, acetyl benzoyl peroxide, diacetyl peroxide, methyl ethyl ketone peroxide, methyl isobutyl ketone peroxide, acetone peroxide, or a mixture of two or more thereof); peroxy acids (e.g., peroxy carboxylic acid); organic hydroperoxides (e.g., t-butyl hydroperoxide, ethylhydroperoxide, or cumene hydroperoxide); inorganic peroxides such as peroxide salts (e.g., alkali metal or alkaline earth metal peroxides); acid peroxides (e.g., peroxymonosulfuric acid or peroxydisulfuric acid); and mixtures of two or more thereof.

The hydrogen peroxide may be derived from any source of hydrogen peroxide. Hydrogen peroxide is typically available as a solution in water. Hydrogen peroxide concentrations of about 3 to about 8% by weight may be used. Commercial grades of about 30% to about 40% by weight, or about 35% by weight, hydrogen peroxide may be used. Commercial grades of about 70 to about 98% by weight hydrogen peroxide may be used. The higher concentrations would be diluted to provide the desired concentrations of hydrogen peroxide that are indicated above.

The antimicrobial agent may comprise a disinfectant, antibiotic, antiseptic, biocide and/or sanitizer. The antimicrobial agent may comprise peracetic acid. The antimicrobial agent may comprise an alcohol, chlorine, a chlorine compound, an aldehyde, an oxidizing agent, iodine, ozone, a phenolic, a quaternary ammonium compound, or a mixture of two or more thereof. The antimicrobial agent may comprise formaldehyde, ortho-phthalaldehyde, glutaraldehyde, silver dihydrogen citrate, polyaminopropyl biguanide, sodium bicarbonate, lactic acid, chlorine bleach, or a mixture of two or more thereof. The antimicrobial agent may comprise methanol, ethanol, n-propanol, 1-propanol, 2-propanol, isopropanol, or a mixture of two or more thereof. The antimicrobial agent may comprise a hypochlorite, chlorine dioxide, a dichloroisocyanurate, a monochloroisocyanurate, a halogenated hydantoin, or a mixture of two or more thereof. The antimicrobial agent may comprise sodium hypochlorite, calcium hypochlorite, sodium dichloroisocyanurate, sodium chlorite, N-chloro-4-methylbenzenesulfonamide sodium salt, 2,4-dichorobenzyl alcohol, or a mixture of two or more thereof. The antimicrobial agent may comprise performic acid, potassium permanganate, potassium peroxymonosulfate, or a mixture of two or more thereof. The antimicrobial agent may comprise phenol, o-phenylphenol, chloroxylenol, hexachlorophene, thymol, amylmetacresol, or a mixture of two or more thereof. The antimicrobial agent may comprise benzalkonuim chloride, cetyltrimethyl ammonium bromide, cetylpyridinium chloride, benzethonium chloride, boric acid, Brilliant green, chlorhexidine gluconate, tincture of iodine, providone-iodine, mercurochrome, manuka honey, octenidine dihydrochloride, polyhexamethylene biguamide, balsam of Peru, or a mixture of two or more thereof. Many of these antimicrobial agents may not be effective in the killing of spores on their own, but when combined with hydrogen peroxide at the concentration levels indicated above many of these antimicrobial agents are useful for killing spores.

The aqueous composition (or second aqueous composition when using a two-step process) may further comprise acetic acid, sulfuric acid, or a mixture thereof. The concentration of acetic acid may range up to about 60% by weight, or from about 0.001 to about 60% by weight, or from about 0.001 to about 30% by weight, or from about 0.001 to about 10% by weight, or from about 0.001 to about 5% by weight, or from about 0.001 to about 2% by weight. The concentration of sulfuric acid may range up to 3% by weight, or from about 0.001 to about 2% by weight. The concentration of each of these may be in the range up to about 1% by weight, or from about 0.001 to about 1% by weight, or from about 0.001 to about 0.5% by weight, or from about 0.001 to about 0.3% by weight.

The aqueous composition (or second aqueous composition when using a two-step process) may further comprise one or more surfactants to provide the aqueous composition with surface active properties, one or more buffers to provide buffering capability (pH modulation), one or more corrosion inhibitors to provide corrosion inhibiting properties, and/or one or more chelators to provide chelation capacity (water softening).

The surfactant may comprise any compound that lowers surface tension or provides greater wettability. The surfactant may comprise one or more detergent, wetting agents, emulsifiers, foaming agents and/or dispersants. The surfactant may comprise one or more organic compounds that contain both hydrophobic groups and hydrophilic groups. The surfactant may comprise both a water insoluble component and a water soluble component. The surfactant may comprise one or more anionic, cationic, zwitterionic and/or nonionic compounds. The surfactant may comprise one or more alkanolamines, alkylarylsulfonates, amine oxides, poly(oxyalkylene)s, block copolymers comprising alkylene oxide repeat units, carboxylated alcohol ethoxylates, ethoxylated alcohols, alkyl phenols, ethoxylated alkyl phenols, ethoxylated amines, ethoxylated amides, oxiranes, ethoxylated fatty acids, ethoxylated fatty esters, ethoxylated oils, fatty esters, fatty acid amides, glycerol esters, glycol esters, sorbitan, sorbitan esters, imidazolines, lecithin, lignin, glycerides (e.g., mono-, di- and/or triglyceride), olefin sulfonates, phosphate esters, ethoxylated and/or propoxylated fatty acids and/or alcohols, sucrose esters, sulfates and/or alcohols and/or ethoxylated alcohols of fatty esters, sulfonates of dodecyl and/or tridecyl benzenes, sulfosuccinates, dodecyl and/or tridecyl benzene sulfonic acids, mixtures of two or more thereof, and the like. The surfactant may comprise ethanolamine, triethanolamine, octyldimethylamine oxide, nonylphenoxy poly(ethyleneoxy)ethanol, polyalkylene glycol, or a mixture of two or more thereof.

The concentration of the surfactant in the aqueous composition (or second aqueous composition when using a two-step process) may be in the range up to about 10% by weight, or from about 0.5 to about 10% by weight, or from about 0.5 to about 6% by weight, or from about 1 to about 4% by weight.

The buffer may comprise an alkali metal phosphate, an alkali metal carbonate, or a mixture thereof. The alkali metal may comprise sodium or potassium. The buffer may comprise one or more of monosodium phosphate, disodium phosphate, trisodium phosphate, monopotassium phosphate, dipotassium phosphate, tripotassium phosphate, sodium carbonate, or a mixture of two or more thereof. Disodium phosphate may be used. The concentration of the buffer in the aqueous composition (or second aqueous composition when using a two-step process) may be in the range up to about 50% by weight, or from about 1% by weight to about 50% by weight, or from about 1% by weight to about 40% by weight, or from about 5% by weight to about 40% by weight, or from about 5% by weight to about 35% by weight.

The corrosion inhibitor may comprise benzotriazole, a sodium salt of benzotriazole, tolyltriazole, a sodium salt of tolyltriazole, or a mixture of two or more thereof. Sodium benzotriazole may be used. A commercially available sodium benzotriazole that may be used is available under the trade designation Cobratec 40S which is believed to be a 40% by weight aqueous solution of sodium benzotriazole. The concentration of the corrosion inhibitor in the aqueous composition (or second aqueous composition when using a two-step process) may be in the range up to about 10% by weight, or from about 0.01% by weight to about 10% by weight, or from about 0.01% by weight to about 5% by weight.

The chelator may comprise ethylenediaminetetraacetic acid, hydroxyethylidenediphosphonic acid, a sodium salt of either of these acids, or a mixture of two or more thereof. A sodium salt of ethylenediaminetetraacetic acid that may be ethylenediaminetetraacetic acid, tetrasodium salt, tetrahydrate. A commercially available ethylenediaminetetraacetic acid, tetrasodium salt, tetrahydrate that may be used may be available from Akzo Nobel under the trade designation Dissolvine 220-S. Dissolvine 220-S is identified by Akzo Nobel as being a chelating agent containing 83-85% by weight ethylenediaminetetraacetic acid, tetrasodium salt, tetrahydrate. The concentration of the chelator in the aqueous composition (or second aqueous composition when using a two-step process) may be in the range up to about 50% by weight, or from about 0.01% by weight to about 50% by weight, or from about 0.1% by weight to about 30% by weight.

The aqueous composition (or second aqueous composition when using a two-step process) may further comprise one or more fragrances, dyes, mixtures thereof, and the like.

The inventive process may comprise contacting spores with the aqueous composition (or the first and second aqueous compositions when using a two-step process) for a sufficient period of time to effect a desired level of reduction (e.g., at least a 4 log reduction, or at least a 5 log reduction, or at least a 6 log reduction) in the number of spores capable of returning to vegetative growth, or in an embodiment, capable of reproduction, metabolism and/or growth. When contacted, the spores may be on a substrate. The substrate may be made of any material including brass, copper, aluminum, stainless steel, carbon steel, rubber, plastic, glass, wood, painted surface, or a combination of two or more thereof. The substrate may comprise a table top, counter top, floor, wall, ceiling, window, door, door handle, sink, faucet, toilet, toilet seat, and the like. The substrate may comprise a medical, dental, pharmaceutical, veterinary or mortuary device. The substrate may comprise human skin.

The temperature of the aqueous composition (or the first and second aqueous compositions when using a two-step process) when applied to or contacting the spores may be in the range from about 10° C. to about 70° C., or from about 20° C. to about 60° C., or from about 25° C. to about 55° C., or from about 30° C. to about 50° C. The temperature may be in the range from about 20° C. to about 26° C., or from about 21° C. to about 25° C., or from about 22° C. to about 24° C., or about 22° C., or about 23° C. The temperature may be room temperature. The aqueous composition may be applied using any standard technique including spraying, brushing, dipping, and the like.

The spores that may be treated (i.e., killed) include bacterial spores. The spores may comprise bacteria of the Bacillus or Clostridia genera. The spores may comprise Geobacillus stearothermophilus, Bacillus atrophaeus, Bacillus subtilis, Bacillus pumilus, Bacillus coagulans, Clostridium sporogenes, Bacillus subtilis globigii, Bacillus cereus, Bacillus circulans, Bacillus anthracis, or a mixture of two or more thereof. The spores may comprise one or more Bacillus subtilis strains and/or wild type Bacillus subtilis spores.

### Examples

The efficacy of the inventive process is assessed using a time kill suspension test method and spores of Bacillus subtilis.

Peracetic acid (PAA) and hydrogen peroxide (H₂O₂) are prepared as concentrated stocks (3× concentrate). Each test contains 100 μl of the PAA concentrate and 100 μl of the H₂O₂ concentrate. Controls containing only PAA or H₂O₂ are also prepared. These contain 100 μl of either the PAA concentrate or H₂O₂ concentrate and 100 μl of de-ionized water. To each test, 100 μl of spores are added while starting the timer concurrently. The samples are mixed thoroughly. The temperature of the samples is room temperature. At the appropriate contact times, 10 μl of the appropriate test sample are placed into 90 μl of the appropriate neutralizing solution, mixed thoroughly and incubated for at least 10 minutes. Ten fold serial dilutions are prepared through 10⁻⁶ and plated using the drop counting method. The plates are then incubated aerobically at 37° C. for 1-2 days. Following incubation, colony forming units (CFU) are counted using standard plate count techniques and converted to log 10 values for analysis.

The results are indicated in the tables below.

TABLE 1
Time (min) to achieve 4 log reduction for various PAA/H₂O₂ combinations
(calculated from curves fitted to time/kill data)

| | | | | | | | | |
|---|---|---|---|---|---|---|---|---|
| H₂O₂ | 6.40 | 48.64 | 15.68 | 7.2 | 7.36 | 3.67 | 2.14 | 1.36 |
| concentration (%) | 3.20 | 97.28 | 15.68 | 13.12 | 8.24 | 3.92 | 2.28 | 1.68 |
| (% by weight) | 1.60 | 168.96 | 28.16 | 24.32 | 14.08 | 4.64 | 3.52 | 1.82 |
| | 0.80 | 343.04 | 33.7 | 32.96 | 19.36 | 7.6 | 3.96 | 1.9 |
| | 0.40 | 639.34 | 92.16 | 69.12 | 43.52 | 14.08 | 6.4 | 2.08 |
| | 0.20 | 1213.99 | 286.72 | 209.12 | 92.16 | 32 | 11.92 | 2.22 |
| | 0.10 | 2305.13 | — | — | 337.92 | 54.4 | 19.36 | 3.28 |
| | 0.00 | — | 711625 | 67744.68 | 6449.101 | 613.9362 | 70.40 | 4.64 |
| | | 0.00 | 0.005 | 0.01 | 0.02 | 0.04 | 0.08 | 0.16 |

PAA concentration (% by weight)

TABLE 2
PAA kill time divided by PAA/H₂O₂ kill time from values in table 1 (i.e. Potentiation
of PAA activity in the presence of H₂O₂)

| | | | | | | | | |
|---|---|---|---|---|---|---|---|---|
| H₂O₂ concentration (% | 6.40 | — | 45384.25 | 9408.98 | 876.24 | 167.29 | 32.90 | 3.41 |
| by weight) | 3.20 | — | 45384.25 | 5163.47 | 782.66 | 156.62 | 30.88 | 2.76 |
| | 1.60 | — | 25270.77 | 2785.55 | 458.03 | 132.31 | 20.00 | 2.55 |
| | 0.80 | — | 21116.47 | 2055.36 | 333.11 | 80.78 | 17.78 | 2.44 |
| | 0.40 | — | 7721.63 | 980.10 | 148.19 | 43.60 | 11.00 | 2.23 |
| | 0.20 | — | 2481.95 | 323.95 | 69.98 | 19.19 | 5.91 | 2.09 |
| | 0.10 | — | — | — | 19.08 | 11.29 | 3.64 | 1.41 |
| | | 0.00 | 0.005 | 0.01 | 0.02 | 0.04 | 0.08 | 0.16 |

PAA concentration (% by weight)

TABLE 3
H₂O₂ kill time divided by PAA/H₂O₂ kill time from values in table 1
(i.e. Potentiation of H₂O₂ activity in the presence of PAA)

| | | | | | | | | |
|---|---|---|---|---|---|---|---|---|
| H₂O₂ concentration | 6.40 | — | 3.10 | 6.76 | 6.61 | 13.25 | 22.73 | 35.76 |
| (% by weight) | 3.20 | — | 6.20 | 7.41 | 11.81 | 24.82 | 42.67 | 57.90 |
| | 1.60 | — | 6.00 | 6.95 | 12.00 | 36.41 | 48.00 | 92.84 |
| | 0.80 | — | 10.18 | 10.41 | 17.72 | 45.14 | 86.63 | 180.55 |
| | 0.40 | — | 6.94 | 9.25 | 14.69 | 45.41 | 99.90 | 307.38 |
| | 0.20 | — | 4.23 | 5.81 | 13.17 | 37.94 | 101.84 | 546.84 |
| | 0.10 | — | — | — | 6.82 | 42.37 | 119.07 | 702.78 |
| | | 0.00 | 0.005 | 0.01 | 0.02 | 0.04 | 0.08 | 0.16 |

PAA concentration (% by weight)

The values shown in Table 1 represent the time taken (minutes) to achieve a 4 log reduction in spore count in the presence of either PAA or H₂O₂ alone, or in combination with each other. For PAA concentrations 0.005, 0.01, 0.02 and 0.04% (in the absence of H₂O₂), the values shown are extrapolated based on the experimental data obtained for PAA concentrations 0.08, 0.16 and 0.32%. Similarly, for H₂O₂ concentrations 0.1, 0.2 and 0.4% (in the absence of PAA), the values shown are extrapolated from experimental data. All other values are generated from spore kill data.

Table 2 illustrates the potentiation of spore killing by PAA when in the presence of H₂O₂. At higher PAA concentrations (0.08 and 0.16% PAA) relatively little activity is gained by the addition of even very high concentrations of H₂O₂. For example, 0.16% PAA is only 3.41 times more active in the presence of 6.4% H₂O₂, as compared to the activity of 0.16% PAA alone.

However, as the concentration of PAA is reduced, the effect of adding H₂O₂ becomes more dramatic, with PAA spore killing activity being hundreds, thousands and even tens of thousands of times greater when in the presence of low concentrations of H₂O₂. For example, 0.02% PAA is 333.11 times more active in combination with 0.8% H₂O₂ than when used alone.

Table 3 illustrates the potentiation of spore killing by H₂O₂ when in the presence of PAA. The enhancement of the spore killing activity of H₂O₂ when in the presence of PAA is far less pronounced, with relative improvement in the spore killing activity of H₂O₂ in combination with all but the highest concentrations of PAA being no greater than about 100 times.

While the invention has been explained in relation to various embodiments, it is to be understood that modifications thereof may become apparent to those skilled in the art upon reading the specification. Therefore, it is to be understood that the scope of the invention specified herein is intended to include all modifications that may fall within the scope of the appended claims.

1-43. (canceled)

44. A process for killing spores, comprising: contacting the spores with an aqueous composition comprising water, an antimicrobial agent and a peroxide for a sufficient period of time to effect at least a 4 log reduction in the number of spores capable of returning to vegetative growth, the aqueous composition having a concentration of peroxide in the water in the range from about 0.01 to about 14% by weight.

45. The process of claim 44 wherein the concentration of the antimicrobial agent is in the range from about 0.001 to about 95% by weight.

46. The process of claim 44 wherein the concentration of the antimicrobial agent is in the range from about 0.005 to about 0.5% by weight.

47. The process of claim 44 wherein the weight ratio of the antimicrobial agent to the peroxide is in the range from about 0.001 to about 0.5.

48. The process of claim 44 wherein the water comprises tap water, deionized water, distilled water, water purified by osmosis, or a mixture of two or more thereof.

49. The process of claim 44 wherein he peroxide is a compound containing an oxygen-oxygen single bond, a peroxide group and/or a peroxide ion.

50. The process of claim 44 wherein the peroxide comprises an organic peroxide, a peroxy acid, an organic hydroperoxide, an inorganic peroxide, an acid peroxide, or a mixture of two or more thereof.

51. The process of claim 44 wherein the peroxide comprises hydrogen peroxide.

52. The process of claim 44 wherein the antimicrobial agent comprises a disinfectant, antibiotic, antiseptic, biocide and/or sanitizer.

53. The process of claim 44 wherein the antimicrobial agent comprises peracetic acid.

54. The process of claim 44 wherein the antimicrobial agent comprises an alcohol, chlorine, a chlorine compound, an aldehyde, an oxidizing agent, iodine, ozone, a phenolic, a quaternary ammonium compound, or a mixture of two or more thereof.

55. The process of claim 44 wherein the antimicrobial agent comprises formaldehyde, ortho-phthalaldehyde, glutaraldehyde, silver dihydrogen citrate, polyaminopropyl biguanide, sodium bicarbonate, lactic acid, chlorine bleach, or a mixture of two or more thereof.

56. The process of claim 44 wherein the antimicrobial agent comprises methanol, ethanol, n-propanol, 1-propanol, 2-propanol, isopropanol, or a mixture of two or more thereof.

57. The process of claim 44 wherein the antimicrobial agent comprises a hypochlorite, chlorine dioxide, a dichloroisocyanurate, a monochloroisocyanurate, a halogenated hydantoin, or a mixture of two or more thereof.

58. The process of claim 44 wherein the antimicrobial agent comprises sodium hypochlorite, calcium hypochlorite, sodium dichloroisocyanurate, sodium chlorite, N-chloro-4-methylbenzenesulfonamide sodium salt, 2,4-dichorobenzyl alcohol, or a mixture of two or more thereof.

59. The process of claim 44 wherein the antimicrobial agent comprises performic acid, potassium permanganate, potassium peroxymonosulfate, or a mixture of two or more thereof.

60. The process of claim 44 wherein the antimicrobial agent comprises phenol, o-phenylphenol, chloroxylenol, hexachlorophene, thymol, amylmetacresol, or a mixture of two or more thereof.

61. The process of claim 44 wherein the antimicrobial agent comprises benzalkonuim chloride, cetyltrimethyl ammonium bromide, cetylpyridinium chloride, benzethonium chloride, boric acid, Brilliant green, chlorhexidine gluconate, tincture of iodine, providone-iodine, mercurochrome, manuka honey, octenidine dihydrochloride, polyhexamethylene biguamide, balsum of Peru, or a mixture of two or more thereof.

62. The process of claim 44 wherein the aqueous composition further comprises acetic acid, sulfuric acid, or a mixture thereof.

63. The process of claim 44 wherein the aqueous composition comprises from about 0.005 to about 0.16% by weight peracetic acid, and from about 0.1 to about 6.4% by weight hydrogen peroxide.

64. The process of claim 44 wherein the aqueous composition further comprises a surfactant, a buffer, a corrosion inhibitor, a chelator, or a mixture of two or more thereof.

65. The process of claim 64 wherein the surfactant comprises a detergent, wetting agent, emulsifier, foaming agent and/or dispersant.

66. The process of claim 64 wherein the surfactant comprises an organic compound that contains hydrophobic groups and hydrophilic groups.

67. The process of claim 64 wherein the surfactant comprises an anionic, cationic, zwitterionic and/or nonionic compound.

68. The process of claim 64 wherein the surfactant comprises: an alkanolamine; alkylarylsulfonate; amine oxide; poly(oxyalkylene); block copolymer comprising alkylene oxide repeat units; carboxylated alcohol ethoxylate; ethoxylated alcohol; alkyl phenol; ethoxylated alkyl phenol; ethoxylated amine; ethoxylated amide; oxirane; ethoxylated fatty acid; ethoxylated fatty ester; ethoxylated oil; fatty ester; fatty acid amide; glycerol ester; glycol ester; sorbitan; sorbitan ester; imidazoline; lecithin; lignin; glyceride; olefin sulfonate; phosphate ester; ethoxylated fatty acid; propoxylated fatty acid; ethoxylated fatty alcohol; propoxylated fatty alcohol; sucrose ester; sulfate, alcohol and/or ethoxylated alcohol of a fatty ester; sulfonate of dodecyl and/or tridecyl benzene; sulfosuccinate; dodecyl and/or tridecyl benzene sulfonic acid; ethanolamine; triethanolamine; octyldimethylamine oxide; nonylphenoxy poly(ethyleneoxy)ethanol; polyalkylene glycol; or a mixture of two or more thereof.

69. The process of claim 64 wherein the buffer comprises an alkali metal phosphate, an alkali metal carbonate, or a mixture thereof.

70. The process of claim 64 wherein the corrosion inhibitor comprises benzotriazole, tolyltriazole, a sodium salt of benzotriazole, a sodium salt of tolyltriazole, or a mixture of two or more thereof.

71. The process of claim 64 wherein the chelator comprises ethylenediaminetetraacetic acid, hydroxyethylidenediphosphonic acid, a sodium salt of ethylenediaminetetraacetic acid, a sodium salt of hydroxyethylidenediphosphonic acid, or a mixture of two or more thereof.

72. The process of claim 44 wherein the aqueous composition further comprises a dye, fragrance, or mixture thereof.

73. The process of claim 44 wherein the spores are on a substrate, the spores and the substrate being contacted with the aqueous composition.

74. The process of claim 73 wherein the substrate is made of a material comprising brass, copper, aluminum, stainless steel, carbon steel, rubber, plastic, glass, wood, painted surface, or a combination of two or more thereof.

75. The process of claim 73 wherein the substrate comprises a table top, counter top, floor, wall, ceiling, window, door, door handle, sink, faucet, toilet or toilet seat.

76. The process of claim 73 wherein the substrate comprises a medical, dental, pharmaceutical, veterinary or mortuary device.

77. The process of claim 73 wherein the substrate comprises human skin.

78. The process of claim 44 wherein the temperature of the aqueous composition is in the range from about 10° C. to about 70° C.

79. The process of claim 44 wherein the spores comprise bacterial spores.

80. The process of claim 44 wherein the spores comprise bacteria of the Bacillus or Clostridia genera.

81. The process of claim 44 wherein the spores comprise Geobacillus stearothermophilus, Bacillus atrophaeus, Bacillus subtilis, Bacillus pumilus, Bacillus coagulans, Clostridium sporogenes, Bacillus subtilis globigii, Bacillus cereus, Bacillus circulans, Bacillus anthracis, or a mixture of two or more thereof.

82. The process of claim 44 wherein the spores comprise one or more Bacillus subtilis strains.

83. A process for killing bacterial spores, comprising: contacting the spores with an aqueous composition comprising water, an antimicrobial agent and hydrogen peroxide for a sufficient period of time to effect at least a 4 log reduction in the number of spores capable of returning to vegetative growth, the aqueous composition having a concentration of hydrogen peroxide in the range from about 0.05 to about 7% by weight.

84. The process of claim 44 wherein the time required to effect at least a 4 log reduction in the number of spores capable of returning to vegetative growth is in the range from about 30 seconds to about 20 minutes.

85-108. (canceled)

109. A process for killing spores, comprising:
contacting the spores with a first aqueous composition comprising water and a peroxide, the aqueous composition having a concentration of peroxide in the range from about 0.01 to about 14% by weight; and
contacting the spores with a second aqueous composition comprising water and an antimicrobial agent for an effective period of time to effect at least a 4 log reduction in the number of spores capable of returning to vegetative growth.

110. The process of claim 109 wherein the concentration of the antimicrobial agent in the second aqueous composition is in the range from about 0.001 to about 95% by weight.

111. The process of claim 109 wherein the concentration of the antimicrobial agent in the second aqueous composition is in the range from about 0.005 to about 0.5% by weight.

112. The process of claim 109 wherein the weight ratio of the antimicrobial agent to peroxide is in the range from about 0.001 to about 0.5.

113. The process of claim 109 wherein the water in the first aqueous composition and the water in the second aqueous composition comprise tap water, deionized water, distilled water, water purified by osmosis, or a mixture of two or more thereof.

114. The process of claim 109 wherein the peroxide is a compound containing an oxygen-oxygen single bond, a peroxide group and/or a peroxide ion.

115. The process of claim 109 wherein the peroxide comprises an organic peroxide, a peroxy acid, an organic hydroperoxide, an inorganic peroxide, an acid peroxide, or a mixture of two or more thereof.

116. The process of claim 109 wherein the peroxide comprises hydrogen peroxide.

117. The process of claim 109 wherein the antimicrobial agent comprises a disinfectant, antibiotic, antiseptic, biocide and/or sanitizer.

118. The process of claim 109 wherein the antimicrobial agent comprises peracetic acid.

119. The process of claim 109 wherein the antimicrobial agent comprises an alcohol, chlorine, a chlorine compound, an aldehyde, an oxidizing agent, iodine, ozone, a phenolic, a quaternary ammonium compound, or a mixture of two or more thereof.

120. The process of claim 109 wherein the antimicrobial agent comprises formaldehyde, ortho-phthalaldehyde, glutaraldehyde, silver dihydrogen citrate, polyaminopropyl biguanide, sodium bicarbonate, lactic acid, chlorine bleach, or a mixture of two or more thereof.

121. The process of claim 109 wherein the antimicrobial agent comprises methanol, ethanol, n-propanol, 1-propanol, 2-propanol, isopropanol, or a mixture of two or more thereof.

122. The process of claim 109 wherein the antimicrobial agent comprises a hypochlorite, chlorine dioxide, a dichloroisocyanurate, a monochloroisocyanurate, a halogenated hydantoin, or a mixture of two or more thereof.

123. The process of claim 109 wherein the antimicrobial agent comprises sodium hypochlorite, calcium hypochlorite, sodium dichloroisocyanurate, sodium chlorite, N-chloro-4-methylbenzenesulfonamide sodium salt, 2,4-dichorobenzyl alcohol, or a mixture of two or more thereof.

124. The process of claim 109 wherein he antimicrobial agent comprises performic acid, potassium permanganate, potassium peroxymonosulfate, or a mixture of two or more thereof.

125. The process of claim 109 wherein the antimicrobial agent comprises phenol, o-phenylphenol, chloroxylenol, hexachlorophene, thymol, amylmetacresol, or a mixture of two or more thereof.

126. The process of claim 109 wherein the antimicrobial agent comprises benzalkonuim chloride, cetyltrimethyl ammonium bromide, cetylpyridinium chloride, benzethonium chloride, boric acid, Brilliant green, chlorhexidine gluconate, tincture of iodine, providone-iodine, mercurochrome, manuka honey, octenidine dihydrochloride, polyhexamethylene biguamide, balsum of Peru, or a mixture of two or more thereof.

127. The process of claim 109 wherein the second aqueous composition further comprises acetic acid, sulfuric acid, or a mixture thereof.

128. The process of claim 109 wherein the second aqueous composition further comprises a surfactant, a buffer, a corrosion inhibitor, a chelator, or a mixture of two or more thereof.

129. The process of claim 128 wherein the surfactant comprises a detergent, wetting agent, emulsifier, foaming agent and/or dispersant.

130. The process of claim 128 wherein the surfactant comprises an organic compound that contains hydrophobic groups and hydrophilic groups.

131. The process of claim 128 wherein the surfactant comprises an anionic, cationic, zwitterionic and/or nonionic compound.

132. The process of claim 128 wherein the surfactant comprises: an alkanolamine; alkylarylsulfonate; amine oxide; poly(oxyalkylene); block copolymer comprising alkylene oxide repeat units; carboxylated alcohol ethoxylate; ethoxylated alcohol; alkyl phenol; ethoxylated alkyl phenol; ethoxylated amine; ethoxylated amide; oxirane; ethoxylated fatty acid; ethoxylated fatty ester; ethoxylated oil; fatty ester; fatty acid amide; glycerol ester; glycol ester; sorbitan; sorbitan ester; imidazoline; lecithin; lignin; glyceride; olefin sulfonate; phosphate ester; ethoxylated fatty acid; propoxylated fatty acid; ethoxylated fatty alcohol; propoxylated fatty alcohol; sucrose ester; sulfate, alcohol and/or ethoxylated alcohol of a fatty ester; sulfonate of dodecyl and/or tridecyl benzene; sulfosuccinate; dodecyl and/or tridecyl benzene sulfonic acid; or a mixture of two or more thereof.

133. The process of claim 128 wherein the surfactant comprises ethanolamine, triethanolamine, octyldimethylamine oxide, nonylphenoxy poly(ethyleneoxy)ethanol, polyalkylene glycol, or a mixture of two or more thereof.

134. The process of claim 128 wherein the buffer comprises an alkali metal phosphate, an alkali metal carbonate, or a mixture thereof.

135. The process of claim 128 wherein the corrosion inhibitor comprises benzotriazole, tolyltriazole, a sodium salt of benzotriazole, a sodium salt of tolyltriazole, or a mixture of two or more thereof.

136. The process of claim 128 wherein the chelator comprises ethylenediaminetetraacetic acid, hydroxyethylidenediphosphonic acid, a sodium salt of ethylenediaminetetraacetic acid, a sodium salt of hydroxyethylidenediphosphonic acid, or a mixture of two or more thereof.

137. The process of claim 109 wherein the first and/or second aqueous composition further comprises a dye, fragrance, or mixture thereof.

138. The process of claim 109 wherein the spores are on a substrate, the spores and the substrate being contacted with the first and the second aqueous compositions.

139. The process of claim 138 wherein the substrate is made of a material comprising brass, copper, aluminum, stainless steel, carbon steel, rubber, plastic, glass, wood, painted surface, or a combination of two or more thereof.

140. The process of claim 138 wherein the substrate comprises a table top, counter top, floor, wall, ceiling, window, door, door handle, sink, faucet, toilet or toilet seat.

141. The process of claim 138 wherein the substrate comprises a medical, dental, pharmaceutical, veterinary or mortuary device.

142. The process of claim 138 wherein the substrate comprises human skin.

143. The process of claim 109 wherein the temperature of the first aqueous composition and the second aqueous composition is in the range from about 10° C. to about 70° C.

144. The process of claim 109 wherein the spores comprise bacterial spores.

145. The process of claim 109 wherein the spores comprise bacteria of the Bacillus or Clostridia genera.

146. The process of claim 109 wherein the spores comprise Geobacillus stearothermophilus, Bacillus atrophaeus, Bacillus subtilis, Bacillus pumilus, Bacillus coagulans, Clostridium sporogenes, Bacillus subtilis globigii, Bacillus cereus, Bacillus circulans, Bacillus anthracis, or a mixture of two or more thereof.

147. The process of claim 109 wherein the spores comprise one or more Bacillus subtilis strains.

148. The process of claim 109 wherein the time required to effect at least a 4 log reduction in the number of spores capable of returning to vegetative growth is in the range from about 30 seconds to about 20 minutes.
